(19) United States
(12) Patent Application Publication
(10) Pub. No.: US 2026/0231951 A1
(43) Pub. Date: Aug. 13, 2026

(54) COATED SEEDS AND METHODS TO IMPROVE CROPS

(71) Applicants: MONTANA STATE UNIVERSITY, Bozeman, MT (US); UNIVERSITY OF IOWA RESEARCH FOUNDATION, Iowa City, IA (US)

(72) Inventors: Michael J. Giroux, Bozeman, MT (US); Alanna J. Oiestad, Bozeman, MT (US); Ned B. Bowden, Iowa City, IA (US)

(73) Assignees: MONTANA STATE UNIVERSITY, Bozeman, MT (US); UNIVERSITY OF IOWA RESEARCH FOUNDATION, Iowa City, IA (US)

(21) Appl. No.: 19/471,302

(22) PCT Filed: Mar. 29, 2024
(86) PCT No.: PCT/US2024/022372

§ 371 Date: Sep. 30, 2025

Related U.S. Application Data
(60) Provisional application No. 63/455,810, filed on Mar. 30, 2023.

(51) Int. Cl. A01N 59/26; A01N 25/30; C07F 9/165

(52) U.S. Cl. CPC A01N 59/26; A01N 25/30; C07F 9/165

(57) ABSTRACT

The invention provides coated seeds, kits comprising coated seeds, and methods for increasing growth, increasing harvest yield, or increasing root length in a plant that grows from a seed by coating the seed prior to planting with a compound of formula I; (I) wherein R¹, R², Z and X have any of the values described in the specification.

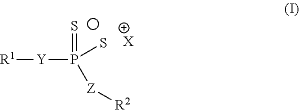

### RELATED APPLICATION

This application claims priority to U.S. Provisional Application No. 63/455,810 that was filed on 30 Mar. 2023. The entire content of U.S. Provisional Application No. 63/455,810 is hereby incorporated by reference herein.

### STATEMENT REGARDING FEDERALLY SPONSORED RESEARCH

This invention was made with government support under AM21SCMPIA1011-00 awarded by the United States Department of Agriculture. The government has certain rights in the invention.

### BACKGROUND

The gaseous compound hydrogen sulfide (H₂S) acts as a signaling molecule in plant physiological processes and stress responses (see Karle S B, et al., 2021, J Plant Growth Reg, 40:2259-2275; Liu D & Pei Y, 2021, Plant Biology, 24:587-593; Thakur M and Anand A., 2021, Physiologia Plantarum, 172:1227-1243; and Choudhary A K, et al., 2022, Plant Biology 104:532-539). Recent research has identified compounds that slowly release H₂S and stimulate plant growth. Dithiophosphates (DTPs) have been identified as likely candidates to help stimulate seed germination and growth of agricultural plants (see Brown E M, et al., 2021, J. Agric. Food Chem. 69:12900-12908; Carter J M, et al., 2019, J. Agric Food Chem. 67:11883-11892; and International Patent Application Publication Number WO 2022/051234). Unlike other slow H₂S releasing compounds, the breakdown of dithiophosphates such as dibutyl dithiophosphate (DBDTP) potassium salt release byproducts that are found in nature and are environmentally friendly. Furthermore, DBDTP increases corn yield when administered as an addition to a commercial liquid starter fertilizer applied in furrow with the seeds (see Brown E M, et al., 2021, J. Agric. Food Chem. 69:12900-12908).

Currently there is a need for methods that can be used to improve root length and/or shoot growth in plants. There is also a need for methods to improved growth, improved harvest yield, improved root length, and/or improved shoot growth in plants using a reduced amount of dithiophosphates.

### SUMMARY

An unplanted seed having a coating that comprises a compound of formula I:

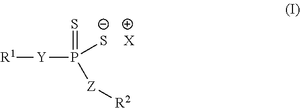

wherein:
   Y is O or S;
   Z is O or S;
   R¹ is (C₁-C₂₀)alkyl, phenyl, or (C₃-C₂₀)cycloalkyl; and R² is (C₁-C₂₀)alkyl, phenyl, or (C₃-C₂₀)cycloalkyl; or R¹ and R² taken together with the atoms to which they are attached form a 5-15 membered heterocyclic ring that is optionally substituted with one or more groups independently selected from the group consisting of (C₁-C₆)alkyl, (C₃-C₆)cycloalkyl, and phenyl, wherein any phenyl or cycloalkyl of R¹ and R² is optionally substituted with one or more groups independently selected from the group consisting of (C₁-C₆)alkyl, (C₃-C₆)cycloalkyl, and phenyl; and
   X⁺ is a suitable cation is provided.

A kit comprising one or more unplanted seeds having a coating and packaging material containing the one or more unplanted seeds having a coating, wherein the packaging material is suitable to allow for transport of the one or more unplanted seeds having a coating is also provided.

A method comprising, increasing growth, increasing harvest yield, increasing shoot growth, or increasing root length in a plant that grows from a seed by coating the seed prior to planting with a compound of formula I:

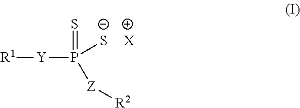

wherein:
   Y is O or S;
   Z is O or S;
   R′ is (C₁-C₂₀)alkyl, phenyl, or (C₃-C₂₀)cycloalkyl; and R² is (C₁-C₂₀)alkyl, phenyl, or (C₃-C₂₀)cycloalkyl; or R¹ and R² taken together with the atoms to which they are attached form a 5-15 membered heterocyclic ring that is optionally substituted with one or more groups independently selected from the group consisting of (C₁-C₆)alkyl, (C₃-C₆)cycloalkyl, and phenyl, wherein any phenyl or cycloalkyl of R¹ and R² is optionally substituted with one or more groups independently selected from the group consisting of (C₁-C₆)alkyl, (C₃-C₆)cycloalkyl, and phenyl; and
   X⁺ is a suitable cation is also provided.

A method for preparing an unplanted seed having a coating, comprising combining a seed and a compound of formula (I) under conditions that provide the unplanted seed having the coating is also provided.

### BRIEF DESCRIPTION OF DRAWINGS

FIG. 1 Shows wheat growth in response to DBDTP. Shoot and root measurements were recorded after 7 days. *, **, *** indicate p-value≤0.05, 0.01, 0.001 respectively using two-tailed, equal variance t-tests comparing each treatment group to the 0 mg/ml DBDTP control.

FIG. 2 Shows pea growth in response to DBDTP. Pea seedling measurements were recorded after 7 days.

FIG. 3 Shows growth of wheat under varying slow-release fertilizer and aqueous delivery of DBDTP at 4 weeks after planting. *, ** *** indicate p-value≤0.05, 0.01, 0.001 respectively using two-tailed, equal variance t-tests comparing each treatment group to the 0 mg/mL DBDTP control.

FIG. 4 Shows tiller number at 21 days after planting in response to seed treatments of three different dithiophosphates (DTPs): dibutyl dithiophosphate (C4), dioctyldithiophosphate (C8), and dihexyldecycldithiophosphate (C16). Each dithiophosphate treatment concentration was administered at 25 mM in a volume of 7% w/v of diluted SPRET non-ionic surfactant. *, indicates p-value≤0.05, 0.01, 0.001 respectively using two-tailed, equal variance t-tests comparing each treatment group to the 0 mg/ml DBDTP control.

FIG. 5 Shows germination rates for DBDTP treated wheat seed. Treatments included application with a non-ionic surfactant.

FIGS. 6A-6B Show plant growth at 35 days after planting in response to lower levels of DBDTP seed treatments applied with a non-ionic surfactant. * indicates p-value≤0.05 using two-tailed, equal variance t-tests comparing each treatment group to the 0 mg/mL DBDTP control.

FIGS. 7A-7B Show field trial results for tiller number (A) and grain yield (B) of DBDTP treated MT Dagmar spring wheat seed plots. Tiller number was counted in a 1 ft section in the center of the first row of each plot with n=15. *, **, *** indicate p-value≤0.05, 0.01, 0.001 respectively using two-tailed, equal variance t-tests comparing each treatment group to the 0 mg/mL DBDTP control.

FIGS. 8A-8B Show field trial results for biomass (A) and seed pod yield (B) of DBDTP treated Provider bush beans.

FIGS. 9A-9B Show growth of lentil in response to varying concentrations of DBDTP administered with SPRET non-ionic surfactant at 1.5% w/V.

FIG. 10 Shows radish fresh root weight from 2023 field trials.

FIG. 11 Shows pea seed weight from 2023 field trials. Seed yield per plant represents the total seed yield per plot divided by the stand count per plot to get average seed yield per plant.

FIGS. 12A-12B Show growth of chickpea at 14 days after planting in response to varying concentrations of DBDTP seed treatments. DBDTP was added directly into a pesticide slurry.

FIGS. 13A-13B Show plant height and tiller number at 14 days from seed treated with Cruiser Maxx Vibrance Cereals seed treatment with the addition of DBDTP.

FIG. 14 Shows pea vine length at 4 weeks after planting in response to aqueous delivery of DBDTP. * indicates p-value≤0.05 using two-tailed, equal variance t-tests comparing each treatment group to the 0 mg/mL DBDTP control.

FIG. 15 shows an illustration of a cross-sectional view of a coated seed including a seed and a coating.

FIG. 16 shows an illustration of a perspective view of a coated seed in which the seed is completely covered by a coating.

FIG. 17 shows an illustration of a perspective view of a coated seed in which the seed is partially covered by a coating.

### DETAILED DESCRIPTION

The following definitions are used, unless otherwise described: halo or halogen is fluoro, chloro, bromo, or iodo. Alkyl, alkoxy, etc. denote both straight and branched groups; but reference to an individual radical such as propyl embraces only the straight chain radical, a branched chain isomer such as isopropyl being specifically referred to.

The term “alkyl”, by itself or as part of another substituent, means, unless otherwise stated, a straight or branched chain hydrocarbon radical, having the number of carbon atoms designated (i.e., C₁₋₈ means one to eight carbons). Examples include (C₁-C₈)alkyl, (C₂-C₈)alkyl, C₁-C₆)alkyl, (C₂-C₆)alkyl and (C₃-C₆)alkyl. Examples of alkyl groups include methyl, ethyl, n-propyl, iso-propyl, n-butyl, t-butyl, iso-butyl, sec-butyl, n-pentyl, n-hexyl, n-heptyl, n-octyl, and and higher homologs and isomers.

The term “cycloalkyl” refers to a saturated or partially unsaturated (non-aromatic) all carbon ring having 3 to 8 carbon atoms (i.e., (C₃-C₈) carbocycle). The term also includes multiple condensed, saturated all carbon ring systems (e.g., ring systems comprising 2, 3 or 4 carbocyclic rings). Accordingly, carbocycle includes multicyclic carbocyles such as a bicyclic carbocycles (e.g., bicyclic carbocycles having about 3 to 15 carbon atoms, about 6 to 15 carbon atoms, or 6 to 12 carbon atoms such as bicyclo[3.1.0]hexane and bicyclo[2.1.1]hexane), and polycyclic carbocycles (e.g tricyclic and tetracyclic carbocycles with up to about 20 carbon atoms). The rings of the multiple condensed ring system can be connected to each other via fused, spiro and bridged bonds when allowed by valency requirements. For example, multicyclic carbocyles can be connected to each other via a single carbon atom to form a spiro connection (e.g., spiropentane, spiro[4,5]decane, etc), via two adjacent carbon atoms to form a fused connection (e.g., carbocycles such as decahydronaphthalene, norsabinane, norcarane) or via two non-adjacent carbon atoms to form a bridged connection (e.g., norbornane, bicyclo[2.2.2]octane, etc). Non-limiting examples of cycloalkyls include cyclopropyl, cyclobutyl, cyclopentyl, cyclohexyl, bicyclo[2.2.1]heptane, pinane, and adamantane.

The term “heterocyclic ring” refers to a single saturated or partially unsaturated ring that has at least one atom other than carbon in the ring, wherein the atom is selected from the group consisting of oxygen, nitrogen and sulfur; the term also includes multiple condensed ring systems that have at least one such saturated or partially unsaturated ring, which multiple condensed ring systems are further described below. Thus, the term includes single saturated or partially unsaturated rings (e.g., 3, 4, 5, 6 or 7-membered rings) from about 1 to 6 carbon atoms and from about 1 to 3 heteroatoms selected from the group consisting of oxygen, nitrogen and sulfur in the ring. The sulfur and nitrogen atoms may also be present in their oxidized forms.

As used herein, the term “heteroatom” is meant to include oxygen (O), nitrogen (N), sulfur (S) and silicon (Si).

As used herein a wavy line “ [symbol] ” that intersects a bond in a chemical structure indicates the point of attachment of the bond that the wavy bond intersects in the chemical structure to the remainder of a molecule.

The phrase “increase the growth of a plant” includes increasing the mass of the plant or the height of the plant. In one embodiment, the mass of the plant is increased by at least about 5%. In another embodiment, the mass of the plant is increased by at least about 10%. In another embodiment, the mass of the plant is increased by at least about 20%. In one embodiment, the height of the plant is increased by at least about 5%. In another embodiment, the height of the plant is increased by at least about 10%. In another embodiment, the height of the plant is increased by at least about 20%.

The phrase “increase the harvest yield of a plant” includes increasing the yield (e.g. volume or mass) of the harvested material from a plant. In one embodiment, the harvest yield of the plant is increased by at least about 1%. In another embodiment, the harvest yield of the plant is increased by at least about 3%. In another embodiment, the harvest yield of the plant is increased by at least about 10%. In another embodiment, the harvest yield of the plant is increased by at least about 20%.

The phrase “increase the root length of a plant” includes increasing the length of the roots of a plant at any timepoint during growth of the plant. In one embodiment, the root length is increased by at least about 1%. In another embodiment, the root length is increased by at least about 3%. In another embodiment, the root length is increased by at least about 10%. In another embodiment, the root length is increased by at least about 20%.

The phrase “increase the shoot growth of a plant” includes increasing the rate at which a shoot grows. In one embodiment, the rate at which a shoot grows is increased by at least about 1%. In another embodiment, the rate at which a shoot grows is increased by at least about 3%. In another embodiment, the rate at which a shoot grows is increased by at least about 10%. In another embodiment, the rate at which a shoot grows is increased by at least about 20%.

The compounds disclosed herein can exist as tautomeric isomers in certain cases. Although only one delocalized resonance structure may be depicted, all such forms are contemplated within the scope of the invention.

Stereochemical definitions and conventions used herein generally follow S. P. Parker, Ed., McGraw-Hill Dictionary of Chemical Terms (1984) McGraw-Hill Book Company, New York; and Eliel, E. and Wilen, S., “Stereochemistry of Organic Compounds”, John Wiley & Sons, Inc., New York, 1994. The compounds of the invention can contain asymmetric or chiral centers, and therefore exist in different stereoisomeric forms. It is intended that all stereoisomeric forms of the compounds of the invention, including but not limited to, diastereomers, enantiomers and atropisomers, as well as mixtures thereof such as racemic mixtures, form part of the present invention. Many organic compounds exist in optically active forms, i.e., they have the ability to rotate the plane of plane-polarized light. In describing an optically active compound, the prefixes D and L, or R and S, are used to denote the absolute configuration of the molecule about its chiral center(s). The prefixes d and l or (+) and (−) are employed to designate the sign of rotation of plane-polarized light by the compound, with (−) or l meaning that the compound is levorotatory. A compound prefixed with (+) or d is dextrorotatory. For a given chemical structure, these stereoisomers are identical except that they are mirror images of one another. A specific stereoisomer can also be referred to as an enantiomer, and a mixture of such isomers is often called an enantiomeric mixture. A 50:50 mixture of enantiomers is referred to as a racemic mixture or a racemate, which can occur where there has been no stereoselection or stereospecificity in a chemical reaction or process. The terms “racemic mixture” and “racemate” refer to an equimolar mixture of two enantiomeric species, devoid of optical activity.

It will be appreciated by those skilled in the art that compounds of the invention having a chiral center may exist in and be isolated in optically active and racemic forms. Some compounds may exhibit polymorphism. It is to be understood that the present invention encompasses any racemic, optically-active, polymorphic, or stereoisomeric form, or mixtures thereof, of a compound of the invention, which possess the useful properties described herein, it being well known in the art how to prepare optically active forms (for example, by resolution of the racemic form by recrystallization techniques, by synthesis from optically-active starting materials, by chiral synthesis, or by chromatographic separation using a chiral stationary phase.

When a bond in a compound formula herein is drawn in a non-stereochemical manner (e.g. flat), the atom to which the bond is attached includes all stereochemical possibilities. When a bond in a compound formula herein is drawn in a defined stereochemical manner (e.g. bold, bold-wedge, dashed or dashed-wedge), it is to be understood that the atom to which the stereochemical bond is attached is enriched in the absolute stereoisomer depicted unless otherwise noted. In one embodiment, the compound may be at least 51% the absolute stereoisomer depicted. In another embodiment, the compound may be at least 60% the absolute stereoisomer depicted. In another embodiment, the compound may be at least 80% the absolute stereoisomer depicted. In another embodiment, the compound may be at least 90% the absolute stereoisomer depicted. In another embodiment, the compound may be at least 95 the absolute stereoisomer depicted. In another embodiment, the compound may be at least 99% the absolute stereoisomer depicted.

Specific values listed below for radicals, substituents, and ranges, are for illustration only; they do not exclude other defined values or other values within defined ranges for the radicals and substituents. It is to be understood that two or more values may be combined. It is also to be understood that the values listed herein below (or subsets thereof) can be excluded.

Specifically, (C₁-C₂₀)alkyl can be methyl, ethyl, propyl, isopropyl, butyl, iso-butyl, sec-butyl, pentyl, 3-pentyl, hexyl, heptyl, octyl, nonyl, decyl, undecyl, dodecyl, tridecyl, tetradecyl, pentadecyl, hexadecyl, heptadecyl, octadecyl, nonadecyl, icosanyl; and (C₃-C₂₀)cycloalkyl can be cyclopropyl, cyclobutyl, cyclopentyl, or cyclohexyl.

A specific value for Y is O.

A specific value for Y is S.

A specific value for Z is O.

A specific value for Z is S.

A specific value for R¹ is (C₁-C₂₀)alkyl.

A specific value for R¹ is (C₁-C₁₅)alkyl.

A specific value for R¹ is (C₁-C₁₀)alkyl.

A specific value for R¹ is (C₅-C₂₀)alkyl.

A specific value for R¹ is (C₅-C₁₅)alkyl.

A specific value for R¹ is (C₅-C₁₀)alkyl.

A specific value for R¹ is C₂-alkyl, C₃-alkyl, C₄-alkyl, C₅-alkyl, C₆-alkyl, C₇-alkyl, C₈-alkyl, C₉-alkyl, C₁₀-alkyl, C₁₁-alkyl, C₁₂-alkyl, C₁₃-alkyl, C₁₄-alkyl, C₁₅-alkyl, C₁₆-alkyl, C₁₇-alkyl, C₁₈-alkyl, C₁₉-alkyl, or C₂₀-alkyl.

A specific value for R¹ is phenyl that is optionally substituted with one or more groups independently selected from the group consisting of (C₁-C₆)alkyl, (C₃-C₆)cycloalkyl, and phenyl.

A specific value for R¹ is (C₃-C₂₀)cycloalkyl that is optionally substituted with one or more groups independently selected from the group consisting of (C₁-C₆)alkyl, (C₃-C₆)cycloalkyl, and phenyl.

A specific value for R¹ is (C₃-C₁₅)cycloalkyl.

A specific value for R¹ is (C₃-C₁₀)cycloalkyl.

A specific value for R¹ is (C₃-C₆)cycloalkyl.

A specific value for R¹ is (C₆-C₁₀)cycloalkyl.

A specific value for R² is (C₁-C₂₀)alkyl.

A specific value for R² is (C₁-C₁₅)alkyl.

A specific value for R² is (C₁-C₁₀)alkyl.

A specific value for R² is (C₅-C₂₀)alkyl.

A specific value for R² is (C₅-C₁₅)alkyl.

A specific value for R² is (C₅-C₁₀)alkyl.

A specific value for R² is C₂-alkyl, C₃-alkyl, C₄-alkyl, C₅-alkyl, C₆-alkyl, C₇-alkyl, C₈-alkyl, C₉-alkyl, C₁₀-alkyl, C₁₁-alkyl, C₁₂-alkyl, C₁₃-alkyl, C₁₄-alkyl, C₁₅-alkyl, C₁₆-alkyl, C₁₇-alkyl, C₁₈-alkyl, C₁₉-alkyl, or C₂₀-alkyl.

A specific value for R² is phenyl that is optionally substituted with one or more groups independently selected from the group consisting of (C₁-C₆)alkyl, (C₃-C₆)cycloalkyl, and phenyl.

A specific value for R² is (C₃-C₂₀)cycloalkyl that is optionally substituted with one or more groups independently selected from the group consisting of (C₁-C₆)alkyl, (C₃-C₆)cycloalkyl, and phenyl.

A specific value for R² is (C₃-C₁₅)cycloalkyl.

A specific value for R² is (C₃-C₁₀)cycloalkyl.

A specific value for R² is (C₃-C₆)cycloalkyl.

A specific value for R² is (C₆-C₁₀)cycloalkyl.

A specific value for R¹ and R² taken together with the atoms to which they are attached is a 5-15 membered heterocyclic ring that is optionally substituted with one or more groups independently selected from the group consisting of (C₁-C₆)alkyl, (C₃-C₆)cycloalkyl, and phenyl, wherein any phenyl of R¹ and R² is optionally substituted with one or more groups independently selected from the group consisting of (C₁-C₆)alkyl, (C₃-C₆)cycloalkyl, and phenyl.

A specific value for R¹ and R² taken together with the atoms to which they are attached is a 5-10 membered heterocyclic ring that is optionally substituted with one or more groups independently selected from the group consisting of (C₁-C₆)alkyl, (C₃-C₆)cycloalkyl, and phenyl, wherein any phenyl of R¹ and R² is optionally substituted with one or more groups independently selected from the group consisting of (C₁-C₆)alkyl, (C₃-C₆)cycloalkyl, and phenyl.

A specific value for R¹ and R² taken together with the atoms to which they are attached is a 5-8 membered heterocyclic ring that is optionally substituted with one or more groups independently selected from the group consisting of (C₁-C₆)alkyl, (C₃-C₆)cycloalkyl, and phenyl, wherein any phenyl of R¹ and R² is optionally substituted with one or more groups independently selected from the group consisting of (C₁-C₆)alkyl, (C₃-C₆)cycloalkyl, and phenyl.

A specific value for R¹ and R² taken together with the atoms to which they are attached is a 5-15 membered heterocyclic ring that is optionally substituted with one or more groups independently selected from the group consisting of (C₁-C₆)alkyl.

A specific value for R¹ and R² taken together with the atoms to which they are attached is a 5-10 membered heterocyclic ring that is optionally substituted with one or more groups independently selected from the group consisting of (C₁-C₆)alkyl.

A specific value for R¹ and R² taken together with the atoms to which they are attached is a 5-8 membered heterocyclic ring that is optionally substituted with one or more groups independently selected from the group consisting of (C₁-C₆)alkyl.

A specific value for R¹ is: methyl, ethyl, propyl, isopropyl, butyl, iso-butyl, sec-butyl, pentyl, iso-pentyl, hexyl, heptyl, octyl, nonyl, decyl, undecyl, dodecyl, tridecyl, tetradecyl, pentadecyl, hexadecyl, heptadecyl, octadecyl, nonadecyl, icosanyl, phenyl, 4-ethylphenyl,

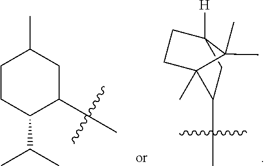 [SMILES: *C1CC(C)CC[C@H]1C(C)C ; *C1CC2CCC1(C)C2(C)C]

A specific value for R² is: methyl, ethyl, propyl, isopropyl, butyl, iso-butyl, sec-butyl, pentyl, iso-pentyl, hexyl, heptyl, octyl, nonyl, decyl, undecyl, dodecyl, tridecyl, tetradecyl, pentadecyl, hexadecyl, heptadecyl, octadecyl, nonadecyl, icosanyl, phenyl, 4-ethylphenyl,

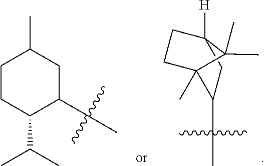 [SMILES: *C1CC(C)CC[C@H]1C(C)C ; *C1CC2CCC1(C)C2(C)C]

A specific compound is selected from the group consisting of:

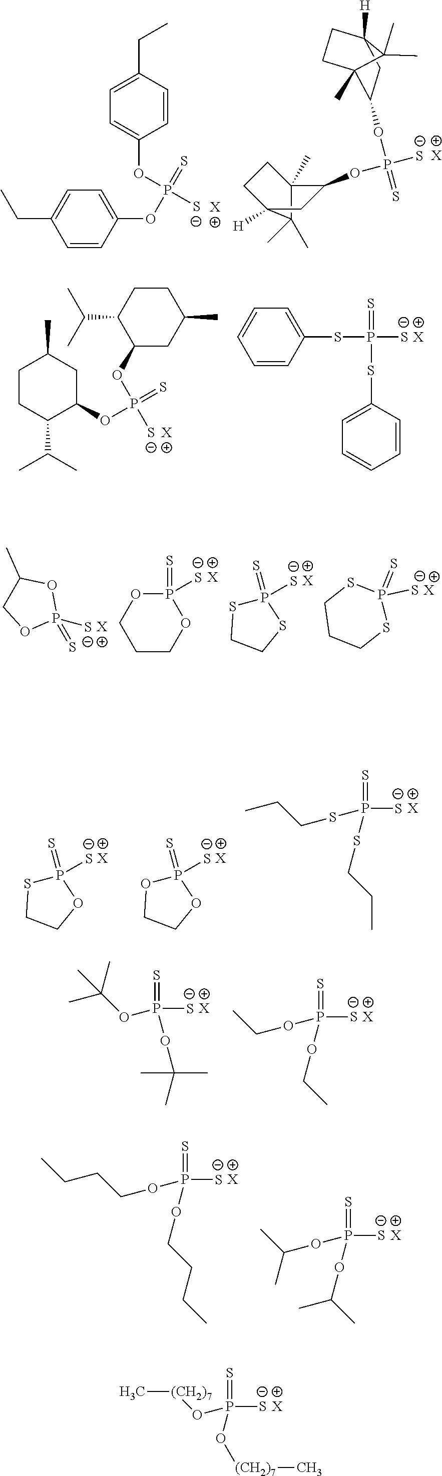

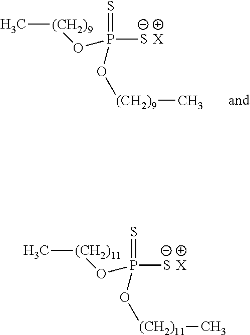

wherein X⁺ is a suitable cation.

A specific compound is selected from the group consisting of:

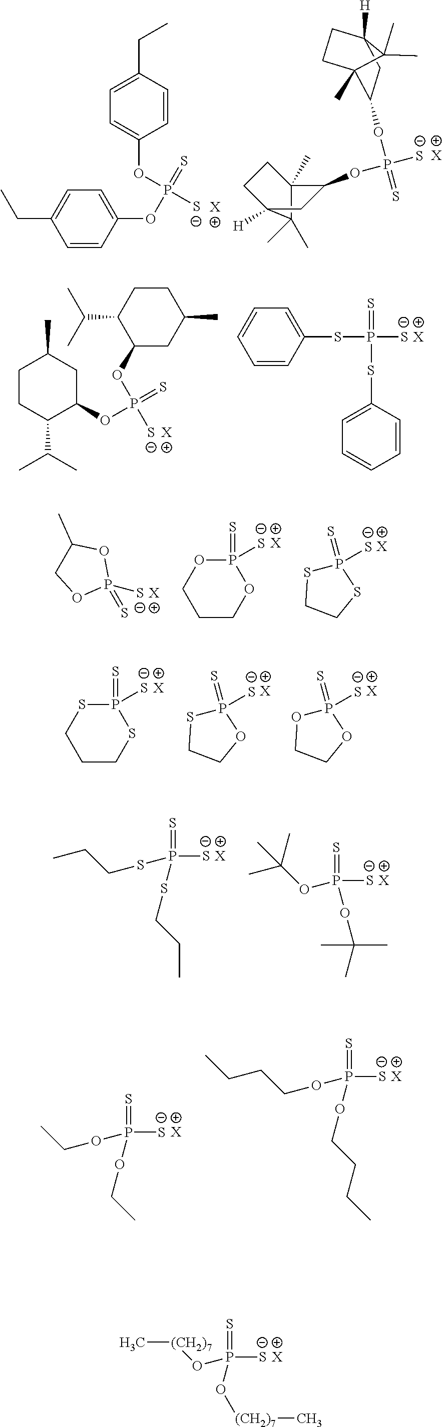

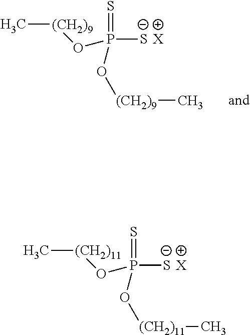

wherein X⁺ is a suitable cation.

A specific compound is selected from the group consisting of:

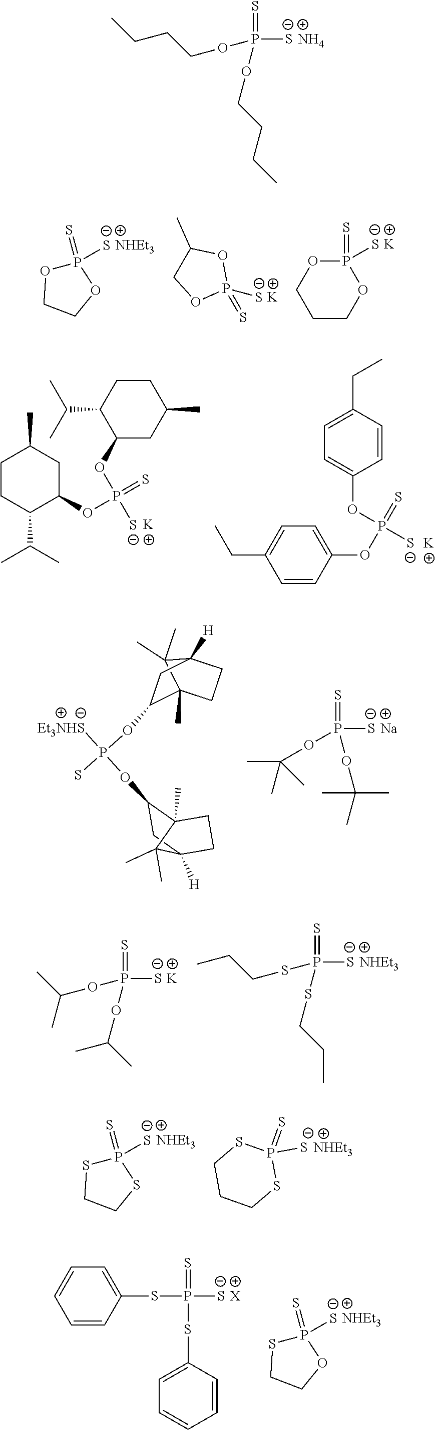

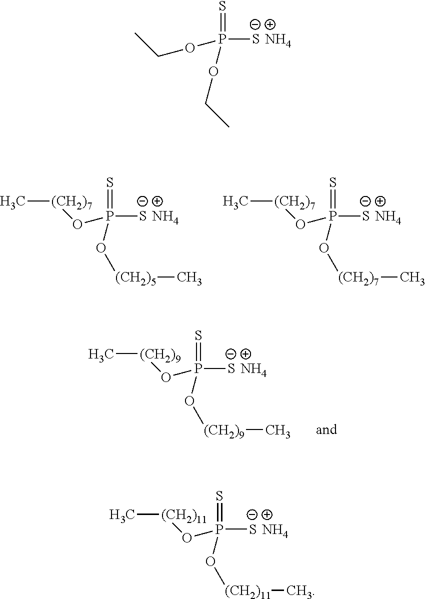

A specific value for X⁺ is a monovalent cation.

A specific value for X⁺ is a metal cation.

A specific value for X⁺ is an ammonium cation (e.g. R₄N⁺, wherein each R is independently selected from (C₁-C₆)alkyl)

A specific value for X⁺ is potassium, sodium, or triethyl ammonium.

### Coated Seeds

As used herein, the term “unplanted seed,” means a seed that has not been planted in the ground.

As used herein, the term “an unplanted seed having a coating,” means an unplanted seed that has a compound of formula (I) on a surface of the seed. In one embodiment, the coating comprises the compound of formula (I). In one embodiment, the coating consists essentially of the compound of formula (I). In one embodiment, the coating completely covers the seed. In one embodiment, the coating covers at least 50% of the seed. In one embodiment, the coating covers at least 75% of the seed. In one embodiment, the coating covers at least 90% of the seed. In one embodiment, the coating covers at least 95% of the seed. In one embodiment, the coating covers at least 99% of the seed. In one embodiment, the coating covers 10%-20% of the seed. In one embodiment, the coating covers 20%-30% of the seed. In one embodiment, the coating covers 30%-40% of the seed. In one embodiment, the coating covers 40%-50% of the seed. In one embodiment, the coating covers 50%-60% of the seed. In one embodiment, the coating covers 60%-70% of the seed. In one embodiment, the coating covers 70%-80% of the seed. In one embodiment, the coating covers 80%-90% of the seed. In one embodiment, the coating covers 90%-100% of the seed.

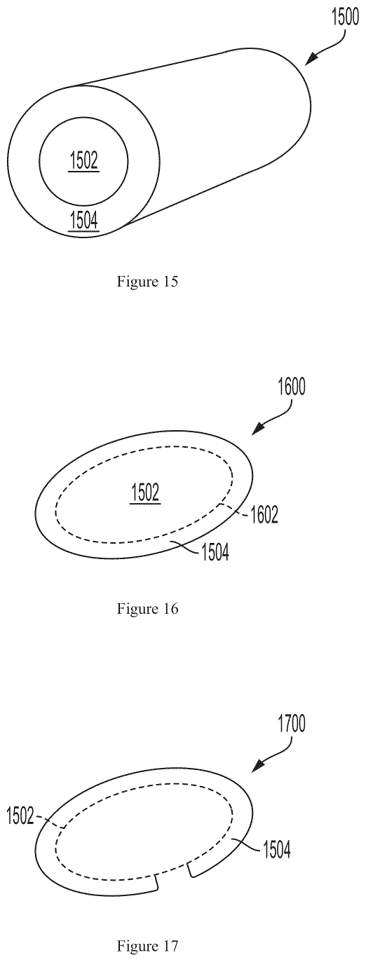

FIG. 15 shows an illustration of a cross-sectional view of a coated seed 1500 including a seed 1502 and a coating 1504. FIG. 16 shows an illustration of a perspective view of a coated seed 1600 in which the seed 1502 (defined by the hidden line 1602) is completely covered by the coating 1504. FIG. 17 shows an illustration of a perspective view of a coated seed 1700 in which the seed 1502 (defined by the hidden line 1602) is partially covered by the coating 1504.

Coating a seed with a compound of formula (I) prior to planting the seed reduces the amount of the compound of formula (I) needed to increase growth, harvest yield, shoot growth, or root length in a plant that grows from the seed compared to the amount of the compound of formula (I) that needed to produce the same increase in growth, harvest yield, shoot growth, or root length if the compound is applied to a field after planting the seed. This provides a significant savings in cost. In one embodiment, the coating comprises 0.5 mg of the compound of formula (I) or less. In another embodiment, the coating comprises 0.4 mg of the compound of formula (I) or less. In another embodiment, the coating comprises 0.3 mg of the compound of formula (I) or less. In another embodiment, the coating comprises 0.2 mg of the compound of formula (I) or less. In another embodiment, the coating comprises 0.1 mg of the compound of formula (I) or less. In another embodiment, the coating comprises 0.05 mg of the compound of formula (I) or less. In another embodiment, the coating comprises 0.03 mg of the compound of formula (I) or less. In another embodiment, the coating consists essentially of 0.5 mg of the compound of formula (I) or less. In another embodiment, the coating consists essentially of 0.4 mg of the compound of formula (I) or less. In another embodiment, the coating consists essentially of 0.3 mg of the compound of formula (I) or less. In another embodiment, the coating consists essentially of 0.2 mg of the compound of formula (I) or less. In another embodiment, the coating consists essentially of 0.1 mg of the compound of formula (I) or less. In another embodiment, the coating consists essentially of 0.05 mg of the compound of formula (I) or less. In another embodiment, the coating consists essentially of 0.03 mg of the compound of formula (I) or less.

Table 9 shows the anticipated amount of DBDTP need to plant one acre of crop using the coated seeds described herein. The amount of DBDTP used per acre is significantly lower than the amount needed when the DBDTP is sprayed onto the field (Table 9).

TABLE 9
Anticipated amount of DBDTP needed to plant
one acre applied as a seed treatment

| | | | Likely Ideal | | |
|---|---|---|---|---|---|
| | Agronomic | Agronomic Seeding | DBDTP | Expected | |
| | Seeding Rate | Rate | Range | Grams DBDTP | |
| Crop | Plants / ft² | Plants / Acre | (mg/seed) | to Apply / Acre | |
| Wheat | 21-28 | 914,760-1,219,680 | 0.008-0.032 | 7.3-39.0 | g |
| Lentil | 12 | 522,720 | 0.03-0.26 | 15.7-135.9 | g |
| Pea | 8 | 348,480 | 0.04-0.31 | 13.9-108.0 | g |
| Chickpea | 4 | 174,240 | 0.05-0.46 | 8.7-80.2 | g |
| Green Bean | 8-12 | 348,480-522,720 | 0.07-0.28 | 24.4-146.4 | g |
| Radish | | 146,000-612,000 | 0.001-0.005 | 0.15-3.1 | g |

* Radish is seeded at 4-10 lbs/acre and seed size = 36,500-61,200 seeds/lb.

### Kits

In one embodiment, a kit comprising one or more unplanted coated seeds and packaging material containing the one or more unplanted coated seeds is provided. The packaging material can be any material that is suitable for storing or transporting the unplanted coated seeds. For example, the packaging material can be an envelope, e.g., a seed envelope, that is suitable for display in a retail setting; the envelope may include illustrations of the seeds or the corresponding plants. The packaging material can also be a bag or other container that can be used for the storage, sale, or transportation of a bulk quantity (e.g., kilograms) of the unplanted coated seeds. For example, the packaging material may comprise plastic or paper.

### Methods

In one embodiment, a method comprising, increasing growth, increasing harvest yield, increasing shoot growth, or increasing root length in a plant that grows from a seed by coating the seed prior to planting with a compound of formula I as described herein is provided. In one embodiment, a method for increasing growth or a method for increasing harvest yield is provided. In one embodiment, a method for increasing shoot growth or a method for increasing root length is provided. In one embodiment, the coating comprises 0.5 mg of the compound of formula (I) or less. In another embodiment, the coating comprises 0.4 mg of the compound of formula (I) or less. In another embodiment, the coating comprises 0.3 mg of the compound of formula (I) or less. In another embodiment, the coating comprises 0.2 mg of the compound of formula (I) or less. In another embodiment, the coating comprises 0.1 mg of the compound of formula (I) or less. In another embodiment, the coating comprises 0.05 mg of the compound of formula (I) or less. In another embodiment, the coating comprises 0.03 mg of the compound of formula (I) or less. In another embodiment, the coating consists essentially of 0.5 mg of the compound of formula (I) or less. In another embodiment, the coating consists essentially of 0.4 mg of the compound of formula (I) or less. In another embodiment, the coating consists essentially of 0.3 mg of the compound of formula (I) or less. In another embodiment, the coating consists essentially of 0.2 mg of the compound of formula (I) or less. In another embodiment, the coating consists essentially of 0.1 mg of the compound of formula (I) or less. In another embodiment, the coating consists essentially of 0.05 mg of the compound of formula (I) or less. In another embodiment, the coating consists essentially of 0.03 mg of the compound of formula (I) or less.

### Coating Methods

In one embodiment, a method comprising combining a seed and a compound of formula (I) under conditions that provide an unplanted seed coated with a compound of formula (I) is provided. In one embodiment, the coating consists essentially of the compound of formula (I). In one embodiment, the coating completely covers the seed. In one embodiment, the coating covers at least 50% of the seed. In one embodiment, the coating covers at least 75% of the seed. In one embodiment, the coating covers at least 90% of the seed. In one embodiment, the coating at least 95% of the seed. In one embodiment, the coating covers at least 99% of the seed. In one embodiment, the coating comprises 0.5 mg of the compound of formula (I) or less. In one embodiment, the coating comprises 0.4 mg of the compound of formula (I) or less. In one embodiment, the coating comprises 0.3 mg of the compound of formula (I) or less. In one embodiment, the coating comprises 0.2 mg of the compound of formula (I) or less. In one embodiment, the coating comprises 0.1 mg of the compound of formula (I) or less. In another embodiment, the coating comprises 0.05 mg of the compound of formula (I) or less. In another embodiment, the coating comprises 0.03 mg of the compound of formula (I) or less. In one embodiment, the coating consists essentially of 0.5 mg of the compound of formula (I) or less. In one embodiment, the coating consists essentially of 0.4 mg of the compound of formula (I) or less. In one embodiment, the coating consists essentially of 0.3 mg of the compound of formula (I) or less. In one embodiment, the coating consists essentially of 0.2 mg of the compound of formula (I) or less. In one embodiment, the coating consists essentially of 0.1 mg of the compound of formula (I) or less. In another embodiment, the coating consists essentially of 0.05 mg of the compound of formula (I) or less. In another embodiment, the coating consists essentially of 0.03 mg of the compound of formula (I) or less.

In one embodiment, the method comprises combining the seed, the compound of formula (I) and a surfactant under conditions that provide an unplanted seed coated with a compound of formula (I). Suitable surfactants include nonionic, cationic and/or anionic surfactants and surfactant mixtures having good emulsifying, dispersing and wetting properties. Examples of suitable surfactants and surfactant mixtures are given in U.S. Pat. Nos. 5,958,835; 6,063,732 and 6,165,939. Also the surfactants customarily used for the art of formulation and described, inter alia, in “Mccutcheon's Detergents and Emulsifiers Annual” MC Publishing Corp., Ridgewood N.J., 1981, Stache, H., “Tensid-Taschenbuch” (Handbook of Surfactants), Carl Hanser Verlag, Munich/Vienna, 1981, and M. and J. Ash, “Encyclopedia of Surfactants”, Vol I-III, Chemical Publishing Co., New York, 1980-81 are suitable for manufacture of the herbicides according to the invention. In one embodiment, the surfactant is a non-ionic surfactant. In one embodiment, the surfactant is SPRET® (Surfactant).

In one embodiment, the method comprises combining the seed, the compound of formula (I) and a pesticide under conditions that provide an unplanted seed coated with a compound of formula (I). Suitable pesticide s include Obvius Plus Specimen fungicide seed treatment (BASF Corporation), Dyna-Shield imidacloprid 5 (Loveland Products), and Cruiser Maxx Vibrance Cereals (Syngenta).

In one embodiment, the method further comprises drying the unplanted seed that is coated with a compound of formula (I).

### Plants

As used herein, the term “plant that grows from a seed” includes any plant that grows from a seed. In one embodiment, the plant that grows from a seed is a beneficial plant. In one embodiment, the plant that grows from a seed is a root vegetable, a seed vegetable, or a leaf vegetable. In one embodiment, the plant that grows from a seed is a fruit, vegetable, hay, alfalfa, an oil seed plant, or miscanthus. In one embodiment, the plant that grows from a seed is a pea, lettuce, tomato, cucumber, green bean, broccoli, squash, beat, onion, sugar, corn (field or sweet), sugar beet, barley, oat, wheat, potato, or radish. In one embodiment, the plant that grows from a seed is corn (field or sweet) or wheat. In one embodiment, the plant that grows from a seed is wheat.

The invention will now be illustrated by the following non-limiting Examples.

### EXAMPLES

### Example 1. Root Growth is Responsive to DTP Application

Growth of two important agricultural crops (wheat and pea) is responsive to DBDTP. The molecular weight of DBDTP=242.3 g/mol and was used for all concentration (molarity) calculations.

### Germination Tests

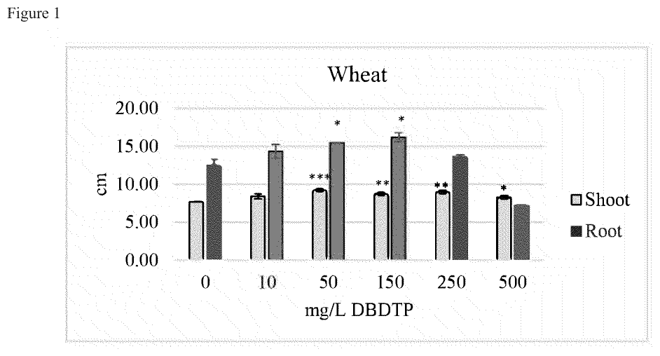

Wheat: For germination tests, 50 wheat seeds were placed within a roll of germination paper using the cigar roll method (Bai C, 2013, J Exp Bot, 64:1745-1753) with n=50. Rolls were placed upright in tubs containing varying concentrations of DBDTP in water, such that the end of the roll was submerged 3″ into the solution. Lids were placed on tubs, then shoot and root length measurements were recorded after 7 days. A positive growth response was observed for wheat within the range of 10-250 mg/L (41.2 μM-1.03 mM) DBDTP compared to the 0 mg/L control (FIG. 1).

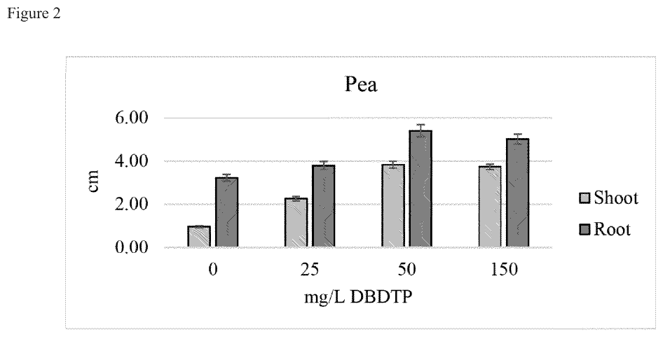

Pea: For germination tests, 25 pea seeds were placed within each roll of germination paper using the cigar method described above. Measurements were recorded after 7 days with n=250. There was a positive growth response to DBDTP was observed at all levels of DBDTP tested (FIG. 2).

### Example 2. Greenhouse Trials

All greenhouse experiments took place under a 16-hour photoperiod with temperatures set to 22° C. day and 18° C. night.

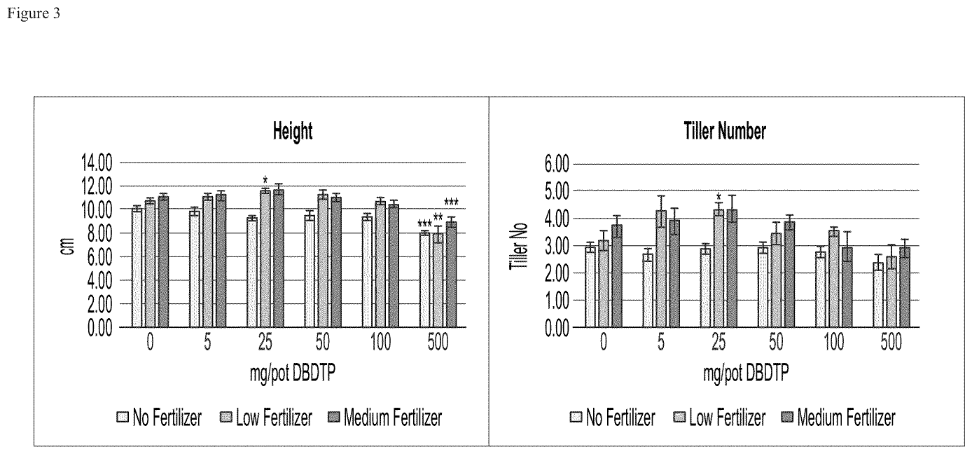

Wheat: To test whether the germination test growth enhancement response observed in wheat would still occur in the presence of added nitrogen fertilizer, wheat was grown under varying levels of slow-release fertilizer (Osmocote) and then watered in with an aqueous solution of DBDTP (see Carter J M, et al., 2019, J. Agric Food Chem. 67:11883-11892). Osmocote was added to potting soil according to the label to achieve low or medium fertilization rates. Prior to planting, pots were watered and seed was sown into moist potting soil. Immediately after planting, each pot was watered with 200 mL water containing, 0, 5, 25, 50, 100, or 500 mg dissolved DBDTP. Pots were not watered for ~5 days after planting to avoid flushing DBDTP out of the pot. Results at 4 weeks after planting show a boost to tiller number at 5 and 25 mg/pot DBDTP in the presence of fertilizer (FIG. 3), indicating that application of DBDTP to wheat seeds is likely a viable option to boost growth.

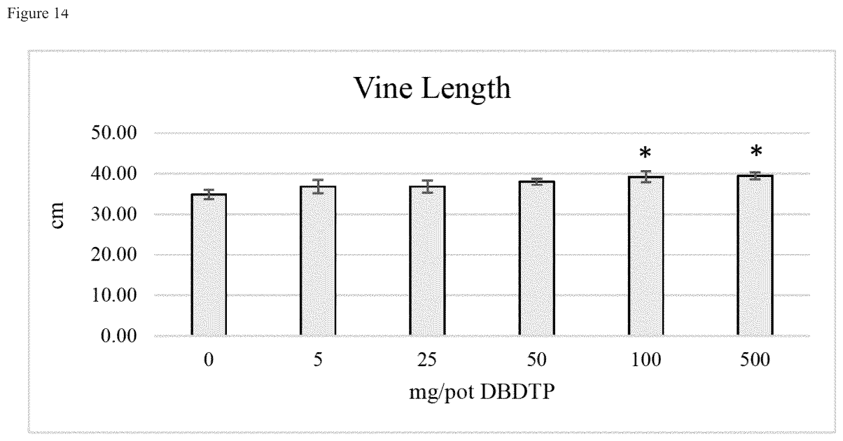

Pea: Prior to planting, pots were watered and seed was sown into moist potting soil. Immediately after planting, each pot was watered with 200 mL water containing, 0, 5, 25, 50, 100, or 500 mg dissolved DBDTP. Pots were not watered for ~5 days after planting to avoid flushing DBDTP out of the pot. Results at 4 weeks after planting show a positive response for each DBDTP treatment for pea, with greatest boost to growth happening at 100 and 500 mg/pot DBDTP (FIG. 14).

### Example 3. Comparison of Wheat Growth in Response to Application of Three Different Dithiophosphates (DTPs)

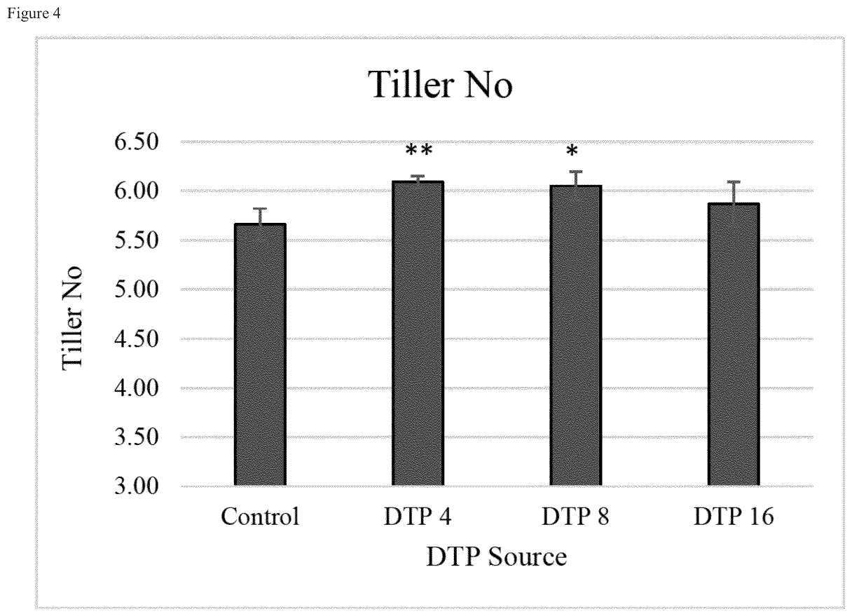

Dithiophosphates have different chemical properties depending on the length of their chains. For instance, the length of the carbon chain influences solubility of the chemical and the rate of H₂S release. Growth of wheat when treated with 25 mM seed treatments of three different DTPs: dibutyldithiophosphate (C4), dioctyldithiophosphate (C8), and dihexyldecycldithiophosphate (C16) was evaluated. Chemical amount per seed used in 25 mM seed treatment applications is described in Table 1. Seed was treated with a 25 mM solution in which the DTP was dissolved in a low concentration of SPRET non-ionic surfactant (Method 1 below). After seeds had dried, they were sown in moist potting soil at a rate of 4 seeds per pot and then not watered for 5 days. There were 5 reps for each treatment where each rep was the average from a single pot. Measurements were collected 21 days after planting. Tiller number was improved for each of the three DTP treatments but was most improved with the dibutyl dithiophosphate (C4) source (FIG. 4).

TABLE 1
Amount of chemical used for direct comparison of 25 mM seed treatments

| | | | mg to treat | mg |
|---|---|---|---|---|
| DTP Chemical | mw | Molarity | 10 g seed | DTP/seed |
| Dibutyl dithiophosphate (C4) | 242.3 | 25 | 4.2 | 0.017 |
| Dioctyldithiophosphate (C8) | 392.14 | 25 | 7 | 0.027 |
| Dihexyldecycldithiophosphate (C16) | 616.39 | 25 | 11 | 0.043 |

### Example 4. Seed Treatments

Two seed treatment methods were examined: 1) Seed treated with DBDTP applied using a non-ionic surfactant and 2) Seed treated with DBDTP added to commonly used pesticide seed treatments (Example 8). For this testing, DBDTP was used as the dithiophosphate source. Note that the seed treatment concentration and volume is not standard across plant species. Each species tolerates a different level of DBDTP and the volume used to treat each species is dependent on seed size. After adding treatment to seed, seed was rolled for 5 minutes. Seed was then exposed to air and allowed to dry completely prior to planting.

Method 1: Combining DBDTP with a Non-Ionic Surfactant

For this method, the non-ionic wetter/spreader surfactant used for all treatments was SPRET (Helena Holding Company). The lowest recommended SPRET concentration was selected from the product label (1.25 mL/L H₂O).

### Wheat

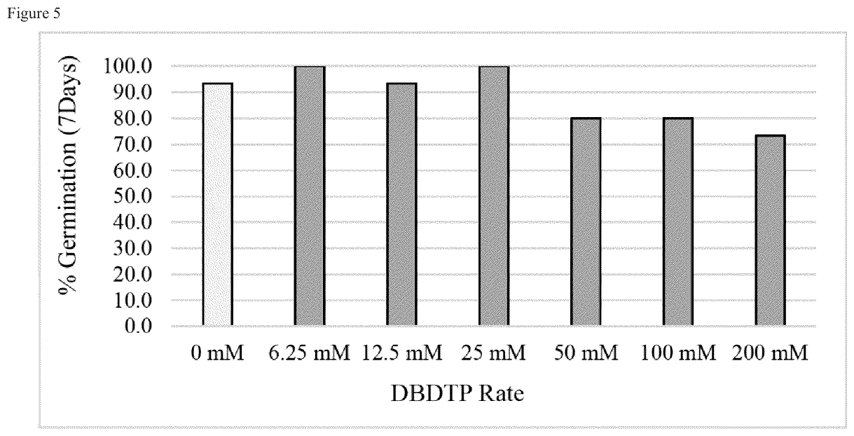

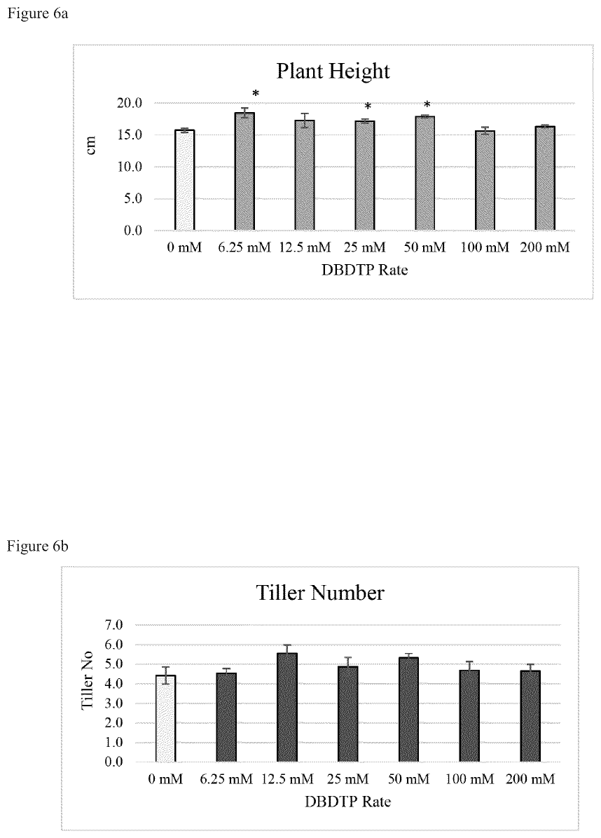

Greenhouse tests to identify ideal DBDTP seed treatment concentrations: A 7% w/v solution was used for each DBDTP treatment to achieve an even coating of wheat seeds. For each DBDTP level, small amounts of DBDTP were dissolved in the SPRET solution according to Table 2 and seed was treated with a 7% w/v solution. Five seeds were sown in 6″ pots and averaged for a single rep. Each DBDTP treatment had three replications. Doses higher than 50 mM were found to reduce germination (FIG. 5), while seed treatments of up to 50 mM DBDTP led to observations of enhanced height and tiller number at 35 days after planting (FIG. 6).

TABLE 2
Amounts of DBDTP used for each seed treatment concentration for wheat.
DBDTP was added to a low concentration of SPRET non-ionic surfactant,
such that a volume of 7% w/v was used to treat seeds.

| | | mg DBDTP/ | μl 1X SPRET | mg DBDTP/ | mL 1X SPRET | mg DBDTP/ |
|---|---|---|---|---|---|---|
| Molarity | | 10 g seed | (7% w/v) | 1000 g seed | (7% w/v) | 35 mg seed |
| 100 | mM | 17 | Bring to 700 μl | 170 | Bring to 70 ml | 0.064 |
| 50 | mM | 8.5 | Bring to 700 μl | 85 | Bring to 70 ml | 0.032 |
| 25 | mM | 4.25 | Bring to 700 μl | 42.5 | Bring to 70 ml | 0.016 |
| 12.5 | mM | 2.125 | Bring to 700 μl | 21.25 | Bring to | 0.008 |
| | | | | | 70 ml | |
| 0 | | 0 | Bring to 700 μl | 0 | Bring to 70 ml | 0.000 |

### Example 5. Field Trial of DBDTP Treated Wheat Seed

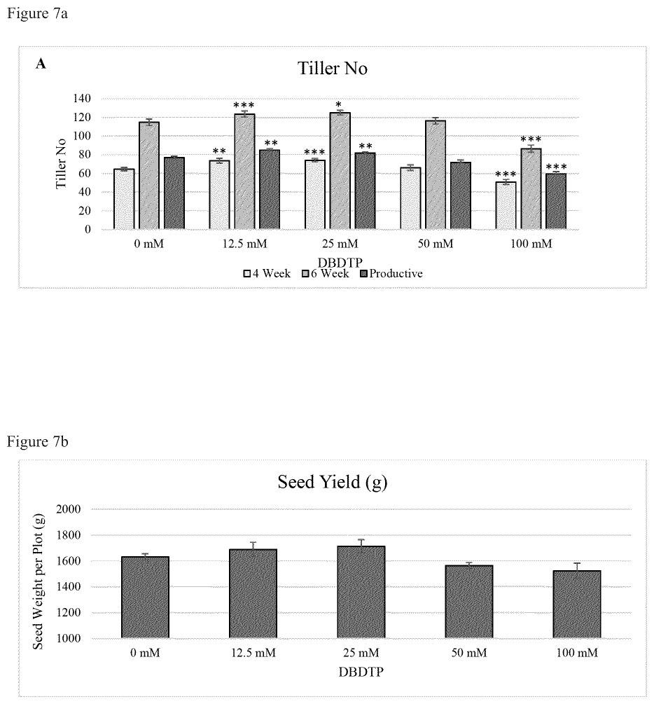

Seed treatment levels consisted of 0, 12.5, 25, 50, and 100 mM DBDTP as in Table 2 and applied in a 7% w/v solution. All seed for each treatment (1000 g) was treated at one time and then once dried it was weighed out for planting in single rows. For each seed treatment level, 15 reps were planted using a complete, randomized block design. Each rep consisted of a 10′, 2 row plot. Plots were seeded at a rate of 10 g/row. Seed was tractor planted, and prior to planting, the field was worked, and N was delivered to achieve 390 Ibs urea/acre. Plant growth was boosted as early as 4 weeks after planting, at the 12.5 and 25 mM levels, with tiller number significantly higher (FIG. 7A), while plant growth and yield were significantly diminished at 100 mM DBDTP (FIG. 7B). The 12.5 mM and 25 mM seed treatments appear to be the best concentrations to boost grain yield as well, as these treatments yielded an average of 3.5-5% higher respectively than the 0 mM control (FIG. 7B). An ideal treatment range encompasses the 12.5 mM and 25 mM treatments and high end of ideal concentrations likely lies between the 25 mM and 50 mM treatments. These concentrations correspond to a range of 0.008 and 0.025 mg DBDTP/seed.

### Example 6. Field Trial of DBDTP Treated Green Bean Seed

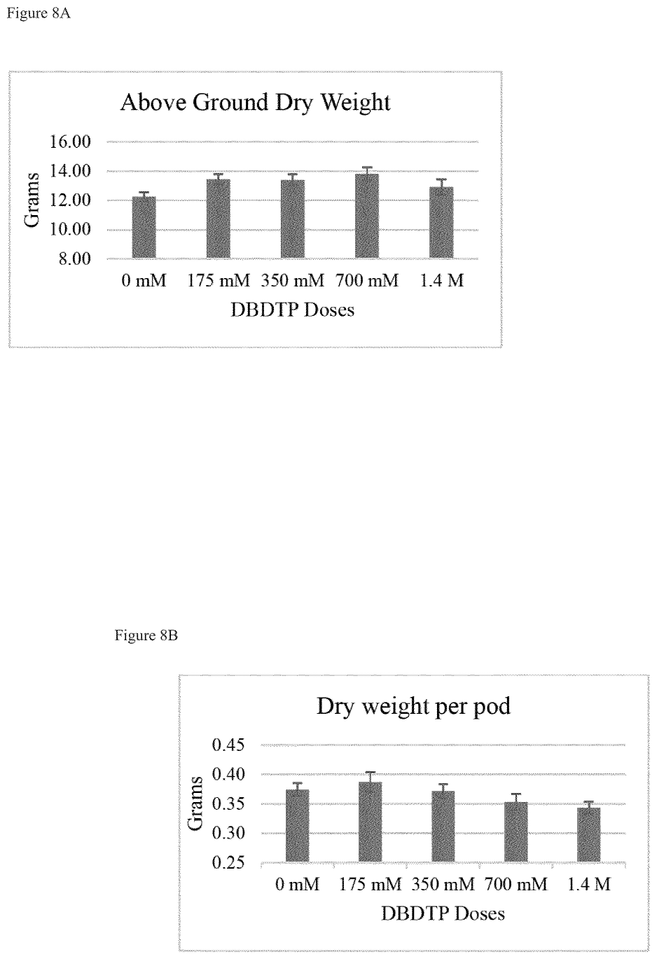

Seed treatment levels consisted of 0, 175 mM, 350 mM, 700 mM, and 1.4 M DBDTP (Table 3) and seed was treated with a 5% w/v solution of diluted SPRET surfactant and DBDTP. The amount of DBDTP each seed received is listed in Table 3. For each seed treatment level, 15 reps were planted using a complete, randomized block design. Each rep consisted of a 3′, 2 row plot with 18 seeds planted per row. Entire plants were harvested at maturity and biomass was averaged for each row. Each row was considered a single rep. For each plot of treated seed, biomass was increased compared to the 0 mM control (FIG. 8A). In addition, at the lowest level tested (175 M), seed pod weight was also increased compared to the control (8B). These results indicate that this treatment may especially beneficial when the goal is to boost overall plant growth in plants similar to green beans, yet it is also possible to boost both growth and seed yield simultaneously. Depending on whether the goal was to increase seed weight, or plant biomass, an ideal treatment range encompasses the 175 mM, 350 mM, and 700 mM treatments. These concentrations correspond to a range of 0.07-0.28 mg DBDTP/seed.

TABLE 3
2023 field trial of DBDTP treated Provider green beans
(bush bean). The individual seed weight was mg/seed.

| | | Volume diluted | |
|---|---|---|---|
| | | SPRET to treat | |
| Dose (Molarity, | mg DBDTP for 190 | 190 g seed (5% | mg DBDTP / |
| mM) | g seed | w/v) | seed |
| 1400 | 323 | Bring to 950 μl | 0.56 |
| 700 | 161.5 | Bring to 950 μl | 0.28 |
| 350 | 80.75 | Bring to 950 μl | 0.14 |
| 175 | 40.375 | Bring to 950 μl | 0.07 |
| 0 | 0 | Bring to 950 μl | 0.00 |

### Example 7. Testing DBDTP Concentration for Lentil Growth

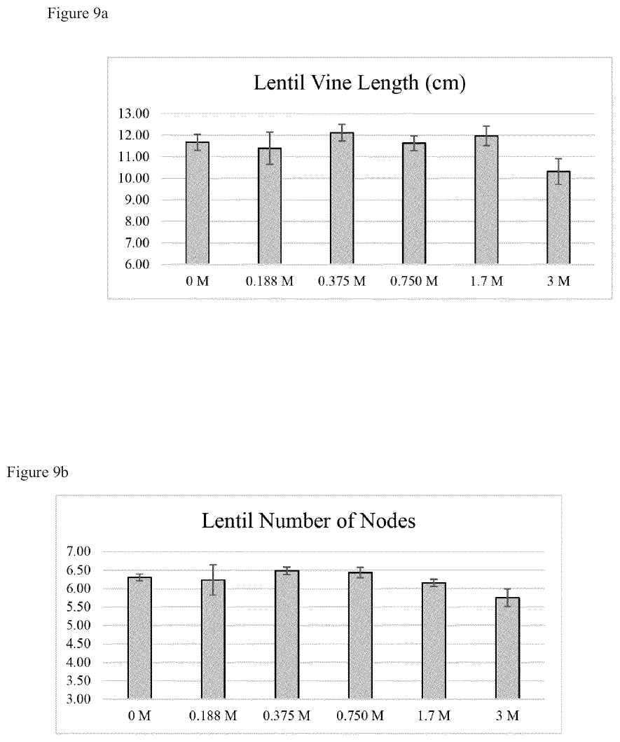

Testing was carried out in the greenhouse. Seed was treated according to Table 4. Prior to planting, pots were watered and seed was sown into moist potting soil. Pots were not watered for 5 days after planting to avoid flushing DBDTP out of the pot. Plant measurements were collected 14 days after planting and shows a positive DBDTP growth response around the 375 mM treatment level (FIG. 9). Seed was treated with a 1.5% w/v solution of diluted SPRET surfactant with addition of DBDTP. Early plant growth was boosted between treatment concentrations 0.188 M-1.7 M. A likely beneficial treatment range lies between 0.03-0.26 mg/seed.

TABLE 4
Amount of DBDTP used for each seed treatment
concentration for Avondale lentil.

| Molarity | mg DBDTP for | Volume diluted SPRET to | mg DBDTP/ |
|---|---|---|---|
| (mM) | 60 lentil seeds | treat 60 seeds (1.5% w/v) | seed |
| 3M | 31.69 | Bring to 43.6 ul | 0.53 |
| 1.67M | 15.85 | Bring to 43.6 ul | 0.26 |
| 750 | 7.92 | Bring to 43.6 ul | 0.13 |
| 375 | 3.96 | Bring to 43.6 ul | 0.07 |
| 187.5 | 1.98 | Bring to 43.6 ul | 0.03 |
| 0 | 0.00 | Bring to 43.6 ul | 0.00 |

### Example 8. Field Trial of DBDTP Treated Radish Seed

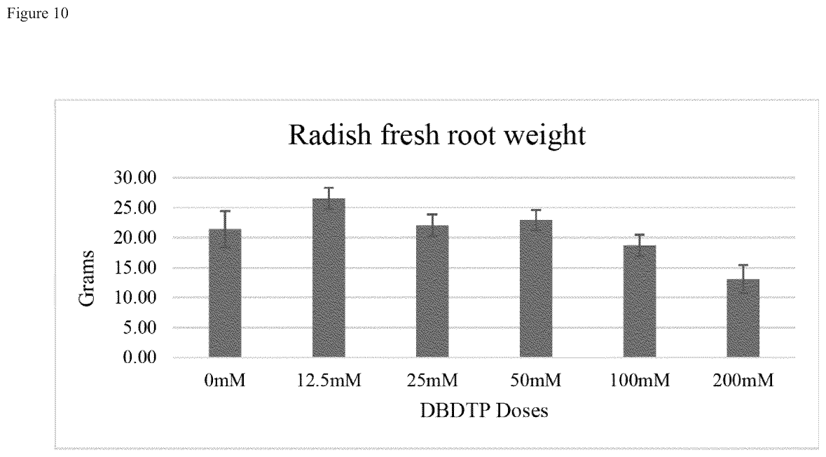

Seed treatment levels consisted of 0, 12.5, 25, 50, and 100 mM DBDTP (Table 5) and seed was treated with a 7% w/v solution of diluted SPRET surfactant and DBDTP. The amount each of DBDTP each seed received is listed in Table 5. For each seed treatment level, 15 reps were planted using a complete, randomized block design. Each rep consisted of a single 3′ row plot. Plots were seeded at a rate of 36 seeds/row and thinned to 4-6″ apart. Root fresh weight was averaged for each row and each row was considered a single rep. Root biomass was increased compared to the control at the 12.5 mM treatment level (FIG. 10). This corresponded to 0.001 mg/seed. Radish root growth likely be enhanced with an application rate in a range of 0.001-0.005 mg DBDTP/seed.

TABLE 5
Amount of DBDTP used for each seed treatment concentration
for 2023 Cherry Belle F1 radish field trial.

| | mg DBDTP for | Volume diluted | |
|---|---|---|---|
| Dose (Molarity, | 3.4 g seed (561 | SPRET to treat 3.4 | mg DBDTP/ |
| mM) | seeds) | g seed (7% w/v) | seed |
| 200 | 11.56 | Bring to 238 μl | 0.021 |
| 100 | 5.78 | Bring to 238 μl | 0.010 |
| 50 | 2.89 | Bring to 238 μl | 0.005 |
| 25 | 1.445 | Bring to 238 μl | 0.003 |
| 12.5 | 0.7225 | Bring to 238 μl | 0.001 |
| 0 | 0 | Bring to 238 μl | 0 |

### Example 9. Seed Treatments

Method 2: Combining DBDTP with Pesticide Seed Treatments

For this method, DBDTP amounts were combined with commonly used seed treatment pesticides using the recommended, crop-specific amount on the product label. The pesticides that were used include Obvius Plus Specimen fungicide seed treatment (BASF Corporation), Dyna-Shield imidacloprid 5 (Loveland Products), and Cruiser Maxx Vibrance Cereals (Syngenta). Pesticide amounts correspond to species-specific recommended amounts on the product label. After treatments were added to seeds, seed was rolled 5 minutes and allowed to dry completely.

### Example 10. Field Trial of DBDTP Treated Green Field Pea

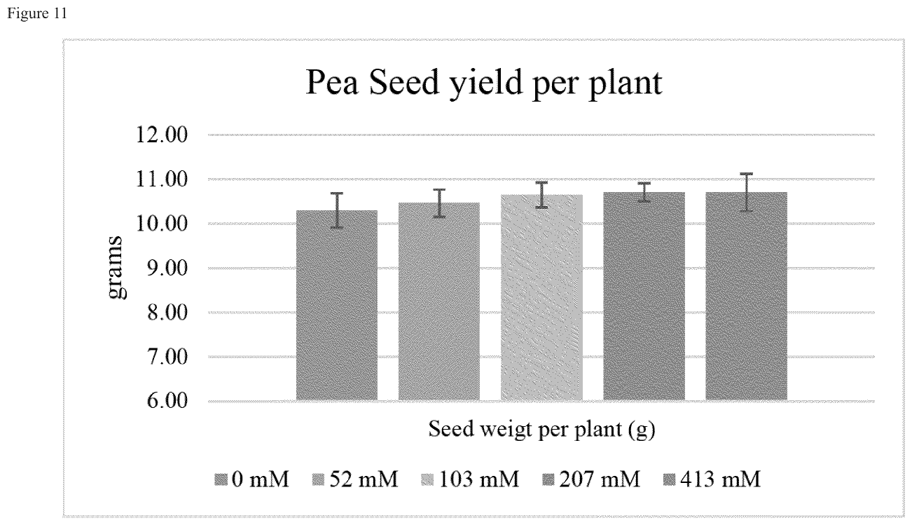

Seed treatment levels consisted of 0, 52, 103, 207, and 413 mM DBDTP (Table 6). Seed was treated with a 1.7% w/v solution that included DBDTP and seed treatment pesticides Dyna-Shield and Obvius (Table 6). After seed was treated and dried, it was inoculated with N Charge Inoculant for Pea, Vetch, and Lentil (Verdesian; 1.40 g/450 g seed) and planted within the same day as inoculating. For each seed treatment level, 15 reps were planted using a complete, randomized block design. Each rep consisted of a 10′, 2 row plot with 60 seeds planted per row. Mature seed was harvested for each plot. For each plot of treated seed, seed yield was increased compared to the control, with 413 mM treated seed yielding being the highest yielding (FIG. 11). Seed yield was increased under all treatment levels tested, in a range of 0.04-0.31 mg/seed.

TABLE 6
Amount of DBDTP used for each seed treatment concentration for MT 457
green field pea 2023 field trial. Individual seed size was 185 mg/seed.

| | mg | | Dyna- | Bring to total | |
|---|---|---|---|---|---|
| Dose | DBDTP | Obvius | Shield | volume using | |
| (Molarity, | for 450 g | Fungicide | Insecticide | water (ml, 1.7% | mg DBDTP |
| mM) | seed | (ml) | (ml) | w/v) | per Seed |
| 413 | 765 | 1.35 | 0.293 | Bring to 7.642 ml | 0.31 |
| 207 | 382.5 | 1.35 | 0.293 | Bring to 7.642 ml | 0.16 |
| 103 | 191.3 | 1.35 | 0.293 | Bring to 7.642 ml | 0.08 |
| 52 | 95.6 | 1.35 | 0.293 | Bring to 7.642 ml | 0.04 |
| 0 | 0 | 1.35 | 0.293 | Bring to 7.642 ml | 0.00 |

### Example 11. Testing DBDTP Concentration for Chickpea Growth

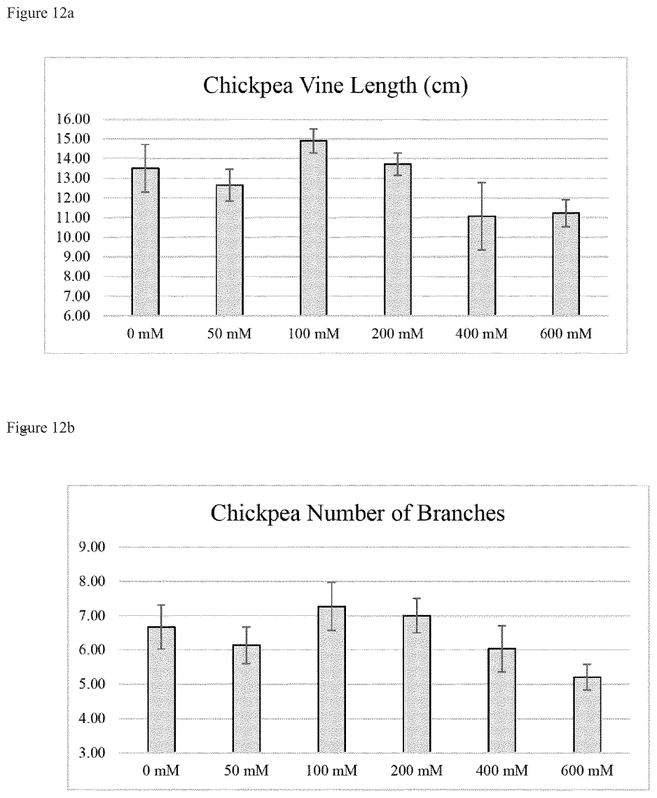

This test took place in the greenhouse. Seed was treated according to Table 7. Prior to planting, pots were watered and seed was sown into moist potting soil. Pots were not watered for 5 days after planting to avoid flushing DBDTP out of the pot. Plant measurements were collected 14 days after planting and show a positive DBDTP growth response at the 100 mM treatment level (FIG. 12). An ideal range likely falls between 0.05-0.46 mg DBDTP/seed.

TABLE 7
Amount of DBDTP used for each seed treatment concentration for chickpea,
such that 14.25 grams of seed corresponded to 30 seeds.

| | | | | Bring to total | |
|---|---|---|---|---|---|
| Dose | mg | | Dyna- | volume using | |
| (Molarity, | DBDTP | Obvius | Shield | water (ml, 2% | mg DBDTP |
| mM) | for 14.25 g | Fungicide | Insecticide | w/v) | per Seed |
| 600 | 41.4 | 14.2 μl | 14.9 μl | Bring to 285 μl | 1.38 |
| 400 | 27.6 | 14.2 μl | 14.9 μl | Bring to 285 μl | 0.92 |
| 200 | 13.8 | 14.2 μl | 14.9 μl | Bring to 285 μl | 0.46 |
| 100 | 6.9 | 14.2 μl | 14.9 μl | Bring to 285 μl | 0.23 |
| 50 | 3.5 | 14.2 μl | 14.9 μl | Bring to 285 μl | 0.12 |
| 0 | 0 | 14.2 μl | 14.9 μl | Bring to 285 μl | 0.00 |

### Example 12. Testing Addition of DBDTP to Cruiser Maxx Vibrance Cereals Slurry for Wheat

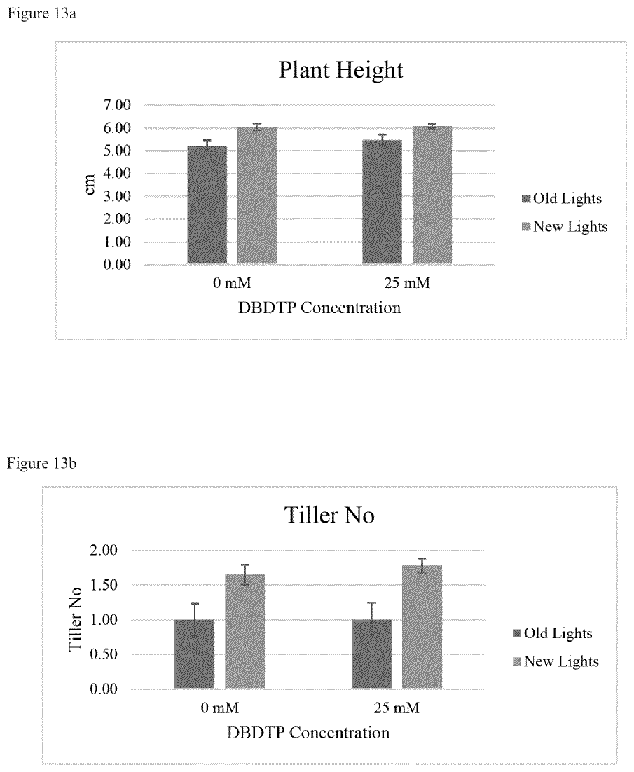

DBDTP was added to a slurry of Cruiser Maxx Vibrance Cereals according to Table 8. Prior to the addition of DBDTP, the pesticide was diluted 1:1 Cruiser:H₂O. DBDTP was added to the diluted Cruiser, such that 2.1 mg DBDTP was added to 62.5 μL to treat 5 g of seed. This experiment was planted in the greenhouse, and at 14 days after planting, the 25 mM treated seed was taller and had more tillers than the 0 mM control (FIG. 13). This experiment was planted in two separate greenhouses-one where the lights had been recently replaced with new LED lights, and one where the old light system remained. In both greenhouses, the 25 mM treated seed outperformed the control (FIG. 13). The main difference observed between the lights was that growth was much enhanced under the new lights, boosting tillering overall. This means that tillering differences due to DBDTP treatment may be observed earlier under the new LED light system.

TABLE 8
Amount of DBDTP to add to achieve a 25
mM solution to treat 5 g of wheat seed.

| | | Molarity | mg to treat 10 g | mg to treat 5 g |
|---|---|---|---|---|
| Chemical | mw | (mM) | seed | seed |
| Dibutyl | 242.3 | 25 | 4.2 | 2.1 |
| dithiophosphate | | | | |

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

1. An unplanted seed having a coating that comprises a compound of formula I: 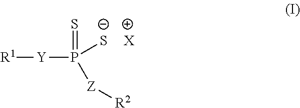
wherein:
Y is O or S;
Z is O or S;
R¹ is (C₁-C₂₀)alkyl, phenyl, or (C₃-C₂₀)cycloalkyl; and R² is (C₁-C₂₀)alkyl, phenyl, or (C₃-C₂₀)cycloalkyl; or R¹ and R² taken together with the atoms to which they are attached form a 5-15 membered heterocyclic ring that is optionally substituted with one or more groups independently selected from the group consisting of (C₁-C₆)alkyl, (C₃-C₆)cycloalkyl, and phenyl, wherein any phenyl or cycloalkyl of R¹ and R² is optionally substituted with one or more groups independently selected from the group consisting of (C₁-C₆)alkyl, (C₃-C₆)cycloalkyl, and phenyl; and
X⁺ is a suitable cation.

2. The unplanted seed of claim 1, wherein Y is O; Z is O; R¹ is (C₁-C₁₀)alkyl; and R² is (C₁-C₁₀)alkyl.

3-5. (canceled)

6. The unplanted seed of claim 1, wherein R¹ is (C₁-C₂₀)alkyl; and R² is (C₁-C₂₀)alkyl.

7-31. (canceled)

32. The unplanted seed of claim 1, wherein R¹ and R² taken together with the atoms to which they are attached form a 5-15 membered heterocyclic ring that is optionally substituted with one or more groups independently selected from the group consisting of (C₁-C₆)alkyl, (C₃-C₆)cycloalkyl, and phenyl, wherein any phenyl of R¹ and R² is optionally substituted with one or more groups independently selected from the group consisting of (C₁-C₆)alkyl, (C₃-C₆)cycloalkyl, and phenyl.

33-37. (canceled)

38. The unplanted seed of claim 1, wherein R¹ is selected from the group consisting of: methyl, ethyl, propyl, isopropyl, butyl, iso-butyl, sec-butyl, pentyl, iso-pentyl, hexyl, heptyl, octyl, nonyl, decyl, undecyl, dodecyl, tridecyl, tetradecyl, pentadecyl, hexadecyl, heptadecyl, octadecyl, nonadecyl, icosanyl, phenyl, 4-ethylphenyl, 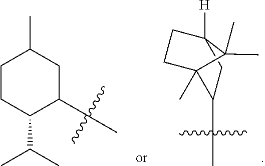 [SMILES: *C1CC(C)CC[C@H]1C(C)C ; *C1CC2CCC1(C)C2(C)C]
and
R² is selected from the group consisting of: methyl, ethyl, propyl, isopropyl, butyl, iso-butyl, sec-butyl, pentyl, iso-pentyl, hexyl, heptyl, octyl, nonyl, decyl, undecyl, dodecyl, tridecyl, tetradecyl, pentadecyl, hexadecyl, heptadecyl, octadecyl, nonadecyl, icosanyl, phenyl, 4-ethylphenyl,

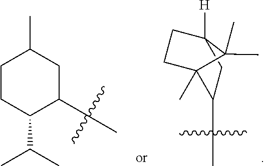 [SMILES: *C1CC(C)CC[C@H]1C(C)C ; *C1CC2CCC1(C)C2(C)C]

39. (canceled)

40. The unplanted seed of claim 1, wherein the compound is selected from the group consisting of: 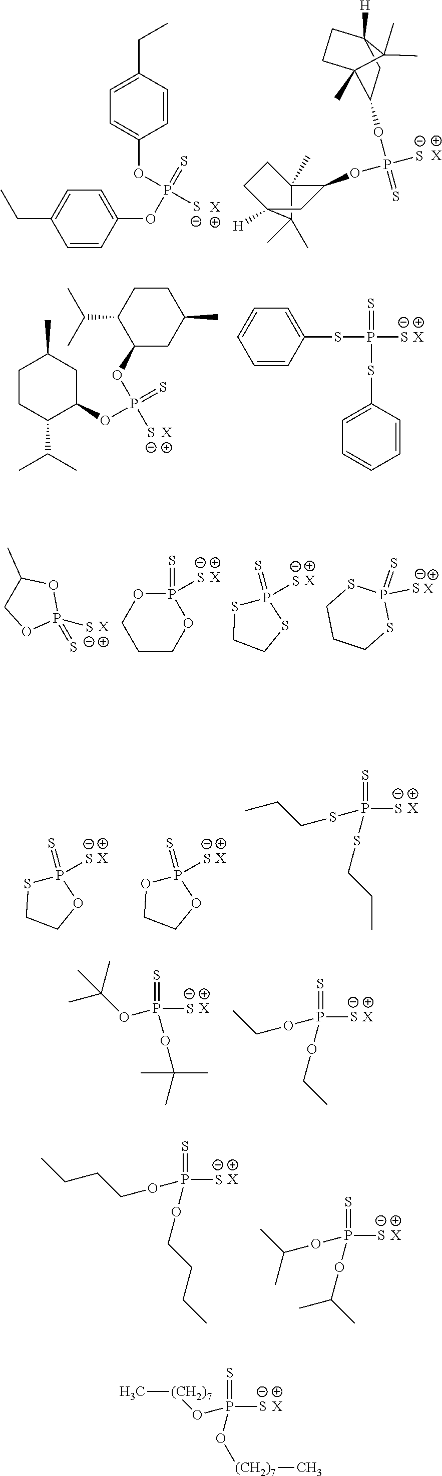 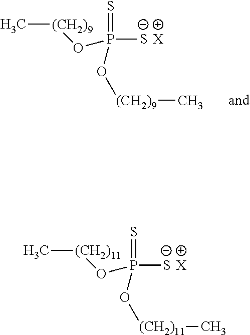
wherein X⁺ is a suitable cation.

41. The unplanted seed of claim 1, wherein the compound is: 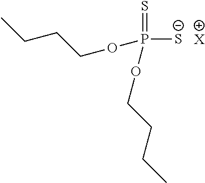
wherein X⁺ is a suitable cation.

42-43. (canceled)

44. The unplanted seed of claim 1, wherein X⁺ is an ammonium cation.

45. (canceled)

46. The unplanted seed of claim 1, wherein the compound is selected from the group consisting of:

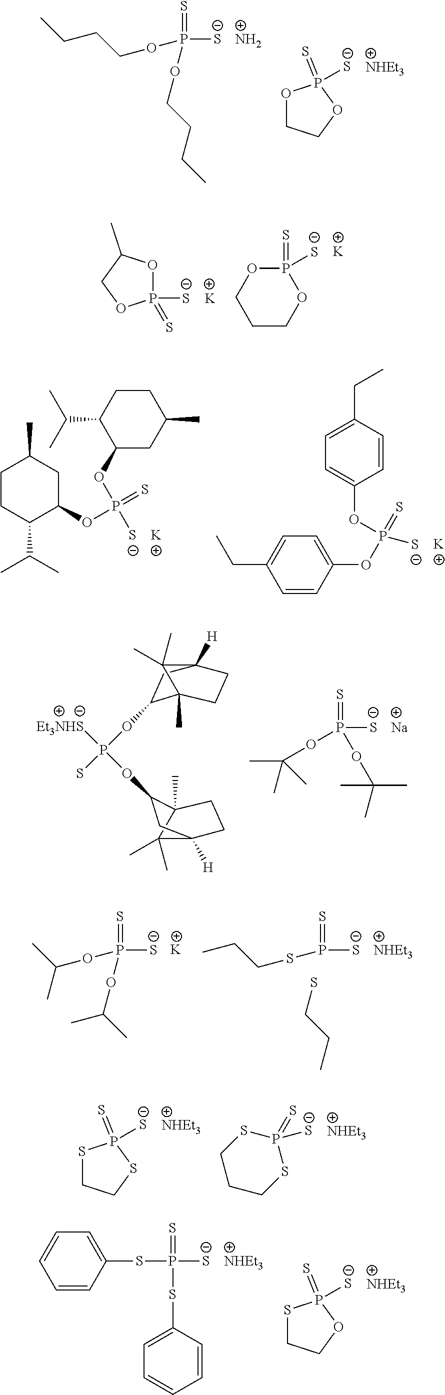

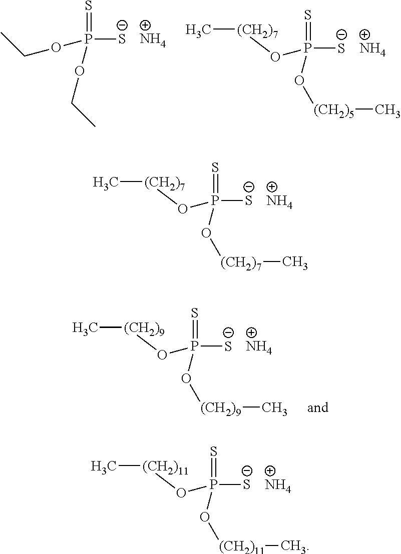

47. The unplanted seed of claim 1, wherein with a coating consists essentially of the compound of formula (I).

48. The unplanted seed of claim 1, wherein the coating completely covers the seed.

49. (canceled)

50. The unplanted seed of claim 1, wherein the coating covers at least 50% of the seed.

51-53. (canceled)

54. The unplanted seed of claim 1, wherein the coating comprises 0.5 mg of the compound of formula (I) or less.

55-57. (canceled)

58. The unplanted seed of claim 1, wherein the coating comprises 0.1 mg of the compound of formula (I) or less.

59-63. (canceled)

64. A kit comprising one or more unplanted seeds having a coating as described in claim 1 and packaging material containing the one or more unplanted seeds having a coating, wherein the packaging material is suitable to allow for storage or transport of the one or more unplanted seeds having a coating.

65-68. (canceled)

69. A method comprising, increasing growth, increasing harvest yield, increasing shoot growth, or increasing root length in a plant that grows from a seed by coating the seed prior to planting with a compound of formula I; 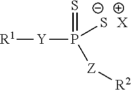
wherein:
Y is O or S;
Z is O or S;
R¹ is (C₁-C₂₀)alkyl, phenyl, or (C₃-C₂₀)cycloalkyl; and R² is (C₁-C₂₀)alkyl, phenyl, or (C₃-C₂₀)cycloalkyl; or R¹ and R² taken together with the atoms to which they are attached form a 5-15 membered heterocyclic ring that is optionally substituted with one or more groups independently selected from the group consisting of (C₁-C₆)alkyl, (C₃-C₆)cycloalkyl, and phenyl, wherein any phenyl or cycloalkyl of R¹ and R² is optionally substituted with one or more groups independently selected from the group consisting of (C₁-C₆)alkyl, (C₃-C₆)cycloalkyl, and phenyl; and
X⁺ is a suitable cation.

70. The method of claim 69, wherein Y is O; Z is O; R¹ is (C₁-C₁₀)alkyl; and R² is (C₁-C₁₀)alkyl.

71-108. (canceled)

109. The method of claim 69, wherein the compound is: 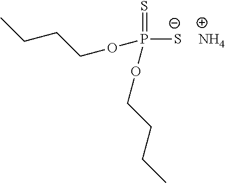
wherein X⁺ is a suitable cation.

110-113. (canceled)

114. The method of claim 69, wherein the compound is selected from the group consisting of:

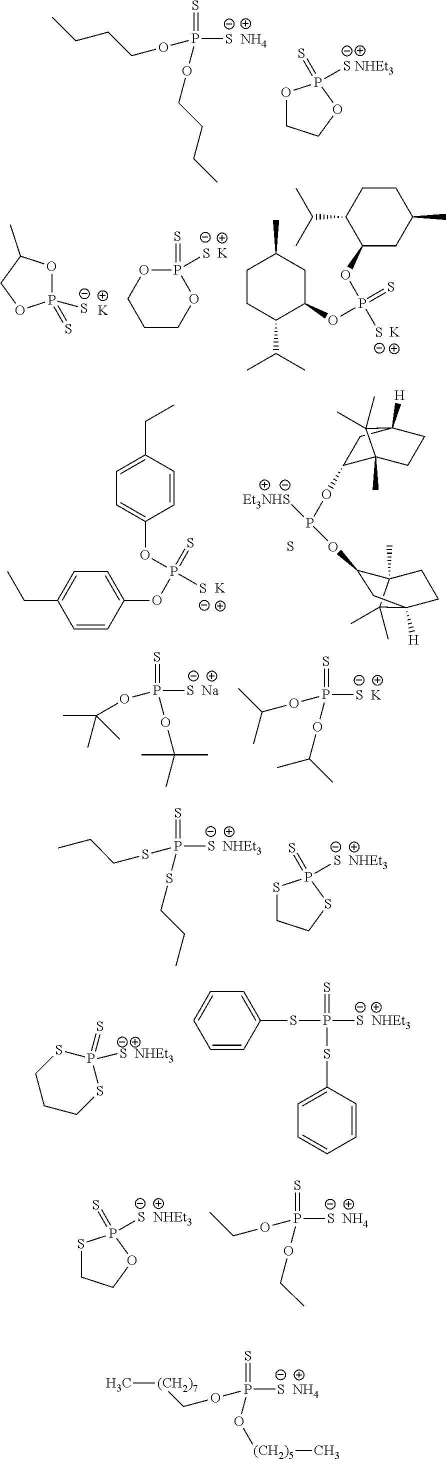

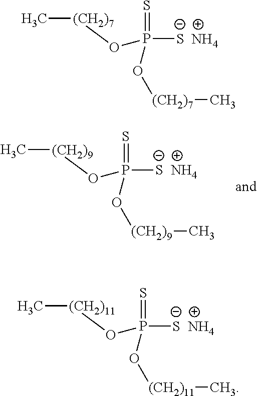

115-133. (canceled)

134. A method for preparing an unplanted seed having a coating as described in claim 1, comprising combining a seed, a compound of formula (I) and a surfactant under conditions that provide the unplanted seed having a coating.

135-159. (canceled)
